(19) United States
(12) Patent Application Publication
(10) Pub. No.: US 2016/0143220 A1
(43) Pub. Date: May 26, 2016

(54) CUTTER HEAD ASSEMBLY, A CUTTER OF THE SAME AND A ROTARY CUTTING MACHINE COMPRISING THE SAME

(71) Applicant: Bessertrim Limited, West Sussex (GB)

(72) Inventor: Brian Child, West Sussex (GB)

(21) Appl. No.: 14/972,723

(22) Filed: Dec. 17, 2015

Related U.S. Application Data
(63) Continuation of application No. PCT/GB2014/000203, filed on May 28, 2014.

(30) Foreign Application Priority Data
Jun. 18, 2013 (GB) 1310873.3

(51) Int. Cl. A01D 34/416

(52) U.S. Cl. CPC A01D 34/4166

(57) ABSTRACT

A cutter head assembly (11, 40) is disclosed comprising a cutter head (11) and a cutter (40). The cutter head (11) has first and second substantially planar and parallel flanges spaced so as to define a channel there between and in which channel the cutter (40) is releasably and pivotally retained therein. The cutter (40) is characterised by a length of cable (31), plastic reinforcement (32) surrounding a portion of the cable (31) , a retaining portion (34) attached to a bare portion of the cable (33) for retaining the cutter in an external cutter head and a collar (41) attached to the retaining portion (34) and axially surrounding a portion of the cable (31).

This application relates to International Application PCT/GB2014/000203, with an International Filing Date of May 28, 2014, which claims the benefit of United Kingdom Application No. 1310873.3, filed Jun. 18, 2013, now Patent No. GB2503997, Issued Jun. 18, 2014, each of which is incorporated by reference in its entirety.

### FIELD OF INVENTION

The present invention relates to a cutter head assembly comprising a cutter head and a cutter; wherein the cutter head has first and second substantially planar and parallel flanges spaced so as to define a channel there between and in which channel the cutter is releasably and pivotally retained therein; and wherein the cutter comprises a length of cable, plastic reinforcement surrounding a portion of the cable and a retaining portion attached to a bare portion of the cable for retaining the cutter in an external cutter head. The present invention also relates to a cutter of the same and a rotary cutting machine such as a grass trimmer or brush cutter comprising the same.

### BACKGROUND TO INVENTION

European patent EP0683969B1 discloses a rotary cutter head assembly comprises a cutting element including a substantially spherical enlarged retaining portion, a filamentary flexible elongate cutting portion, and a substantially cylindrical intermediate strengthening portion, which is integral with and between the retaining portion and the filamentary portion and is of smaller cross-sectional area than that of the retaining portion. Further included is a head having first and second substantially planar and parallel flanges so as to define a channel there between and in which the retaining portion of the cutting element is releasably and pivotally retained. The first flange has an aperture there through having a first aperture portion which is sized such that the enlarged retaining portion of the cutting element is able to pass there through, and a second aperture portion which is sized such that the enlarged retaining portion is unable to pass there through and such that the strengthening and cutting portions are able to pass there through. The second flange has a similar aperture there through, including aperture portions similar to and opposite those in the first flange. The first and second flanges are spaced apart by a dimension which is smaller than the diameter of the retaining portion whereby the retaining portion extends into the first aperture portions in the flanges to retain the retaining portion within the channel.

FIG. 1 illustrates the loading of a Nylon cutter 10 (part number BT40) in to a cutter head 11 (part number BTHD1) of the commercially available ‘Bessertrim Grass Cutting System’ which implements the invention of EP0683969B1 and is located in situ on the end of a grass trimming 12.

FIG. 2 shows, schematically, the Nylon cutter 10 of FIG. 1 in greater detail and, in particular, a spherical retaining portion 21, a cylindrical intermediate strengthening portion 22 including a tapered portion 23 and a filamentary portion 24.

FIG. 3 shows, schematically, a section through an alternative, commercially available, cable reinforced cutter Nylon 30 which is compatible with the Bessertrim Grass Cutting System. It is comprises a length of cable 31 and a Nylon coating 32. During manufacture, the cable has been stripped at one end and the exposed cable splayed 33 whereupon a spherical body 34 has been moulded over the splayed end to form a retaining portion.

In use, such a cable reinforced cutter 30 is demonstrably more robust and durable that a Nylon cutter 20 of the type illustrated in FIG. 2.

It is also noted that such a cable reinforced cutter 30 has an intrinsically safe wear mechanism. In use, it is approximately the last 1.7 cm to 2.5 cm (¾″ to 1″) of a cutter that does the cutting and, in this cutting zone, the Nylon coating 32 will wear away and the exposed wire strands of cable 31 will fray and individually wear away, collectively wearing down the cutter. With a multi-strand woven cable (e.g. 7×7) and with the cutter being pivotable, there is no scope for the cable as a whole to fracture and go ballistic which is of paramount importance to safety. Indeed, even under the most adverse testing to destruction (i.e. not representative of normal use) when the cable reinforced cutter 30 is totally destroyed whereby only a few strands of cable and the spherical retaining portion remain, the spherical retaining portion remains in the channel of the cutter head. It is only when a machine is stopped and shaken that a totally destroyed cutter comprising only the spherical retaining portion and a few strands of cable may fall out of the locating apertures of the cutter head.

### SUMMARY OF INVENTION

In accordance with the present invention, there is provided a cutter head assembly comprising a cutter head and a cutter wherein the cutter head has first and second substantially planar and parallel flanges spaced so as to define a channel there between and in which channel the cutter is releasably and pivotally retained therein; and wherein the cutter comprises a length of cable, plastic reinforcement surrounding a portion of the cable, a retaining portion attached to a bare portion of the cable for retaining the cutter in an external cutter head and a collar attached to the retaining portion and axially surrounding a portion of the cable.

The length of the collar may be sized relative to the flange so as to not protrude out of the channel.

The retaining portion may be a spherical ball which receives the cable and, in particular, an end of the cable. Also, the retaining portion and collar may be integral such as when formed simultaneously by moulding about the cable.

Further provided in accordance with the present invention is a cutter of the same and a rotary cutting machine comprising a drive unit, a shaft and such a cutter head assembly.

### BRIEF DESCRIPTION OF DRAWINGS

FIG. 1 illustrates the loading of a Nylon cutter in to a cutter head of the commercially available ‘Bessertrim Grass Cutting System’ as previously described.

FIG. 2 shows, schematically, the Nylon cutter of FIG. 1 in greater detail as previously described.

FIG. 3 shows, schematically, a section through an alternative, commercially available, cable reinforced Nylon cutter 30 as previously described.

FIG. 4 shows, schematically, a cable reinforced Nylon cutter according to the present invention.

FIG. 5 shows, schematically, the cable reinforced Nylon cutter of FIG. 4 located in situ in the cutter head of the commercially available ‘Bessertrim Grass Cutting System’.

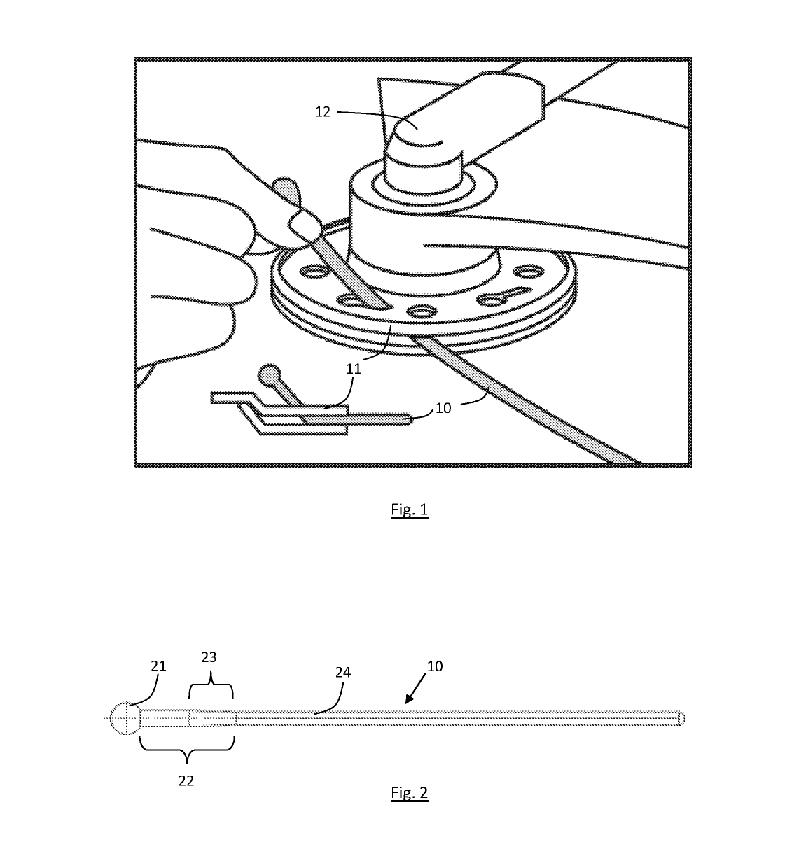

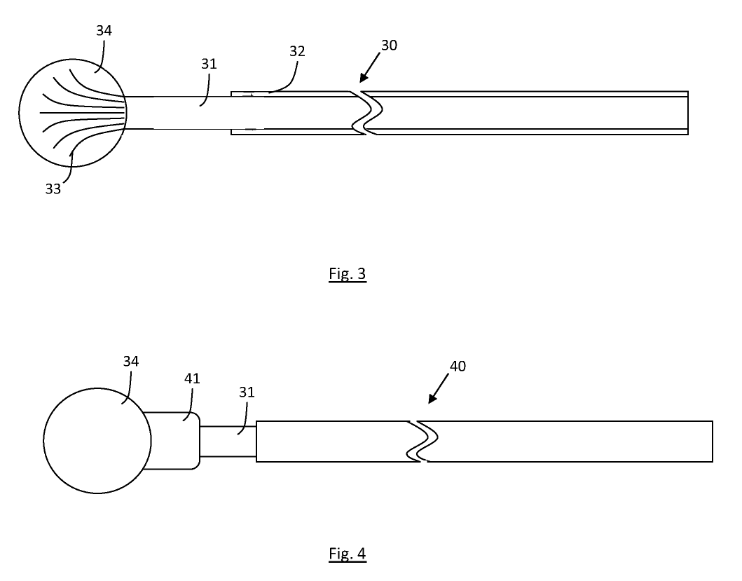

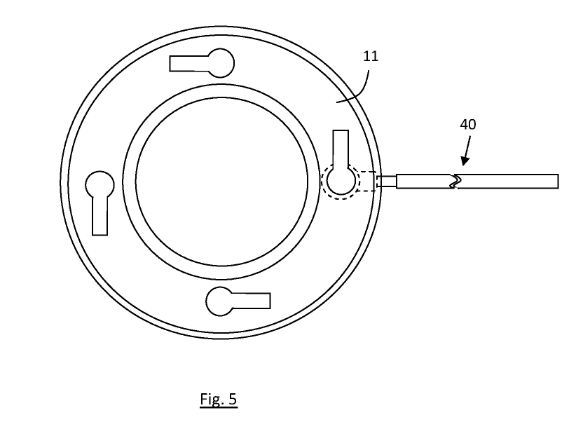

FIG. 4 shows, schematically, a cable reinforced Nylon cutter 40 according to the present invention having the same general configuration as that of FIG. 3 with the exception that the cutter 40 further comprising a collar 41 which is attached to the spherical retaining portion 34 and axially surrounds a portion of the cable. During manufacture, the spherical retaining portion 34 and collar 41 are simultaneously formed from Zinc (though other metals may be used) by moulding about the cable.

FIG. 5 shows, schematically, a plan view of the cable reinforced Nylon cutter 40 of FIG. 4 located in situ in the cutter head 11 of the commercially available ‘Bessertrim Grass Cutting System’ (part number BTHD1). As is evident, the length of the collar is sized relative to the flange so as to not protrude out of the channel, even when the cutter is fully extended outwards as would be the case where the head to be rotating at speed.

The aforementioned collar provides for certain advantages.

First, it limits the ability of a cable reinforced Nylon cutter to oscillate in the channel. This is particularly important for cable reinforced Nylon cutters as cable, with its inherent strength relative to Nylon, can be much thinner than an equivalent strength Nylon cutter and, as has been observed, a thin, cable reinforced Nylon cutter can have a tendency to rattle in the channel. In this regard, it is noteworthy that one cannot readily manufacture a cable reinforced Nylon cutters with a continuous, tapered shape of the moulded Nylon cutter illustrated in FIG. 2.

Secondly, as mentioned even if the cutter is worn to destruction whereby only a few strands of cable remain, the spherical retaining portion and the collar will remain in the channel. In particular, during rotation, the weight of the collar will ensures the collar points outwards thus keeping the spherical retaining portion in the channel. Furthermore, when a machine is stopped, the spherical retaining portion and collar must be aligned to the keyhole shaped aperture of the cutter head 11 of the commercially available ‘Bessertrim Grass Cutting System’ (part number BTHD1) in order to remove it.

Lastly, the length of the collar being sized relative to the flange so as to not protrude out of the channel means that the collar cannot strike external objections during rotation and is therefore not at the risk of damage to the collar were this not to be the case. Also, the additional weight contributed by the collar is minimised, thus minimising the stress on the cutter head during rotation (bearing in mind that when rotating at high speed, the speed of rotation can greatly magnify the effective weight of the collar).

Other implementations of the claimed invention would suggest themselves to those skilled in the art. For example, whilst the claimed invention has been described with reference to the Bessertrim Grass Cutting System, the invention may be equally applicable to other configurations of cutter head and other shapes of cutter retaining portions.

1. A cutter head assembly (11, 40) comprising a cutter head (11) and a cutter (40), wherein the cutter head (11) has first and second substantially planar and parallel flanges spaced so as to define a channel there between and in which channel the cutter (40) is releasably and pivotally retained therein, characterised by the cutter (40) comprising a length of cable (31), plastic reinforcement (32) surrounding a portion of the cable (31), a retaining portion (34) attached to a bare portion of the cable (33) for retaining the cutter in an external cutter head and a collar (41) attached to the retaining portion (34) and axially surrounding a portion of the cable (31).

2. The cutter head assembly (11, 40) according to claim 1, wherein the length of the collar (41) is sized relative to the flange so as to not protrude out of the channel.

3. The cutter head assembly (11, 40) according to claim 1, wherein the retaining portion is a spherical ball which receives the cable.

4. The cutter head assembly (11, 40) according to claim 3, wherein the spherical ball receives an end of the cable.

5. The cutter head assembly (11, 40) according to claim 1, wherein the retaining portion and collar are integral.

6. The cutter head assembly (11, 40) according to claim 5, wherein the retaining portion and collar are simultaneously formed by moulding about the cable.

7. The cutter head assembly (11, 40) according to claim 5, wherein the retaining portion and collar are metal.

8. A cutter (40) of a cutter head assembly (11, 40), wherein the cutter head (11) has first and second substantially planar and parallel flanges spaced so as to define a channel there between and in which channel the cutter (40) is releasably and pivotally retained therein, characterised by the cutter (40) comprising a length of cable (31), plastic reinforcement (32) surrounding a portion of the cable (31), a retaining portion (34) attached to a bare portion of the cable (33) for retaining the cutter in an external cutter head and a collar (41) attached to the retaining portion (34) and axially surrounding a portion of the cable (31).

9. A rotary cutting machine (40, 11, 12) comprising a drive unit, a shaft and a cutter head assembly (40, 11), said cutter head assembly (40, 11) comprising a cutter head (11) and a cutter (40), wherein the cutter head (11) has first and second substantially planar and parallel flanges spaced so as to define a channel there between and in which channel the cutter (40) is releasably and pivotally retained therein, characterised by the cutter (40) comprising a length of cable (31), plastic reinforcement (32) surrounding a portion of the cable (31), a retaining portion (34) attached to a bare portion of the cable (33) for retaining the cutter in an external cutter head and a collar (41) attached to the retaining portion (34) and axially surrounding a portion of the cable (31).

10. The rotary cutting machine (40, 11, 12) according to claim 9, wherein the length of the collar (41) is sized relative to the flange so as to not protrude out of the channel.

11. The rotary cutting machine (40, 11, 12) according to claim 9, wherein the retaining portion is a spherical ball which receives the cable.

12. The rotary cutting machine (40, 11, 12) according to claim 11, wherein the spherical ball receives an end of the cable.

13. The rotary cutting machine (40, 11, 12) according to claim 9, wherein the retaining portion and collar are integral.

14. The rotary cutting machine (40, 11, 12) according to claim 13, wherein the retaining portion and collar are simultaneously formed by moulding about the cable.

15. The rotary cutting machine (40, 11, 12) according to claim 13, wherein the retaining portion and collar are metal.
